(19) United States
(12) Patent Application Publication
(10) Pub. No.: US 2010/0142856 A1
(43) Pub. Date: Jun. 10, 2010

(54) IMAGE READING APPARATUS, AND READING METHOD

(76) Inventors: Shin TAKEUCHI, Tokyo (JP); Hidenobu Takahira, Ebina-shi (JP); Eigo Nakagawa, Ebina-shi (JP); Kazushige Ooi, Ebina-shi (JP); Yoshio Nishihara, Ashigarakami-gun (JP)

Correspondence Address: MORGAN LEWIS & BOCKIUS LLP, 1111 PENNSYLVANIA AVENUE NW, WASHINGTON, DC, 20004, US

(21) Appl. No.: 12/558,054

(22) Filed: Sep. 11, 2009

(30) Foreign Application Priority Data
Dec. 10, 2008 (JP) 2008-314840
Jan. 9, 2009 (JP) 2009-003702

(51) Int. Cl. G06K 9/22

(52) U.S. Cl. 382/314

(57) ABSTRACT

A image reading apparatus includes an pointing part that points a position on a medium that has an image to be read formed thereon, an irradiating unit that irradiates light onto the medium on which the position was pointed by the pointing part, an imaging unit that forms an image of light reflected from the medium irradiated with light by the irradiating unit, a generating unit that generates a signal representing the image to be read that depends on the reflected light whose image is formed by the imaging unit, and a changing unit that varies an direction of the imaging unit, and changes the position on the image that is imaged by the generating unit, within an irradiation range irradiated with light by the irradiating unit.

### CROSS-REFERENCE TO RELATED APPLICATIONS

This application is based on and claims priority under 35 USC 119 from Japanese Patent Applications No. 2008-314840 filed on Dec. 10, 2008 and No. 2009-003702 filed on Jan. 9, 2009.

### BACKGROUND

1. Technical Field

The present invention relates to an image reading apparatus and method.

2. Related Art

In recent years, technologies for converting content written on paper to data, transferring this data to a personal computer, mobile telephone or the like, and displaying the written content on a monitor, or transferring/saving the written content as data have been attracting interest. These technologies use paper on which a large number of tiny dot images are formed in a certain configuration pattern, and a digital pen that digitizes the written content by reading these dot images. This digital pen reads the dot pattern in the vicinity of the pen point with an imaging device when writing is performed on the paper, and specifies the position of the pen point on the paper based on the read dot pattern. It is thereby possible to generate an electronic document composed of written characters, graphics and the like, add characters, graphics and the like to a prescribed electronic document, and so on.

### SUMMARY

According to one aspect of the invention, there is provided an image reading apparatus including: a pointing part that points a position on a medium on which a target image is formed, the target image being an image to be read; an irradiating unit that irradiates light onto the position pointed by the pointing part; an imaging unit that images light reflected from the medium irradiated with the light; a generating unit that generates a signal representing the target image in response to the light imaged by the imaging unit; and a changing unit that changes an direction or a position of the imaging unit.

### BRIEF DESCRIPTION OF THE DRAWINGS

Exemplary embodiments of the present invention will be described in detail based on the following figures, wherein:

FIG. 1 shows the overall configuration of a writing information processing system;

FIG. 2 shows the content of a code pattern image;

FIG. 3 is a functional block diagram showing the configuration of a digital pen;

FIG. 4 is a cross-sectional view showing the configuration of a digital pen;

FIG. 5 is a functional block diagram showing a controller of a digital pen;

FIG. 6 is an output timing chart relating to an illumination control signal, an image capture signal and an output image signal;

FIG. 7 is a flowchart showing operations by a code obtaining unit and a data processing part of a digital pen;

FIGS. 8A to 8C schematically show an irradiation axis a and an irradiation range A of an irradiating unit, and a light receiving axis b and an image acquiring range B of an imaging unit;

FIG. 9 shows an exemplary content written by a digital pen;

FIG. 10 shows an exemplary transition of an image acquiring range by an imaging unit of a digital pen;

FIG. 11 is a characteristic line diagram schematically showing a readable area in the related art;

FIG. 12 is a characteristic line diagram schematically showing a readable area in a first exemplary embodiment;

FIG. 13 is a block diagram showing an exemplary functional configuration of a digital pen;

FIG. 14 is a cross-sectional side view showing an exemplary configuration of a digital pen;

FIG. 15 is a cross-sectional side view showing an exemplary configuration of a digital pen;

FIG. 16 shows an exemplary content written by a digital pen;

FIG. 17 shows an exemplary transition of an image acquiring range by an optics unit of a digital pen;

FIG. 18 shows an exemplary content written by a digital pen;

FIG. 19 shows an exemplary transition of an image acquiring range by an optics unit of a digital pen; and

FIG. 20 is a cross-sectional side view showing an exemplary configuration of a digital pen.

### DETAILED DESCRIPTION

### 1. First Exemplary Embodiment

### 1-1. Configuration

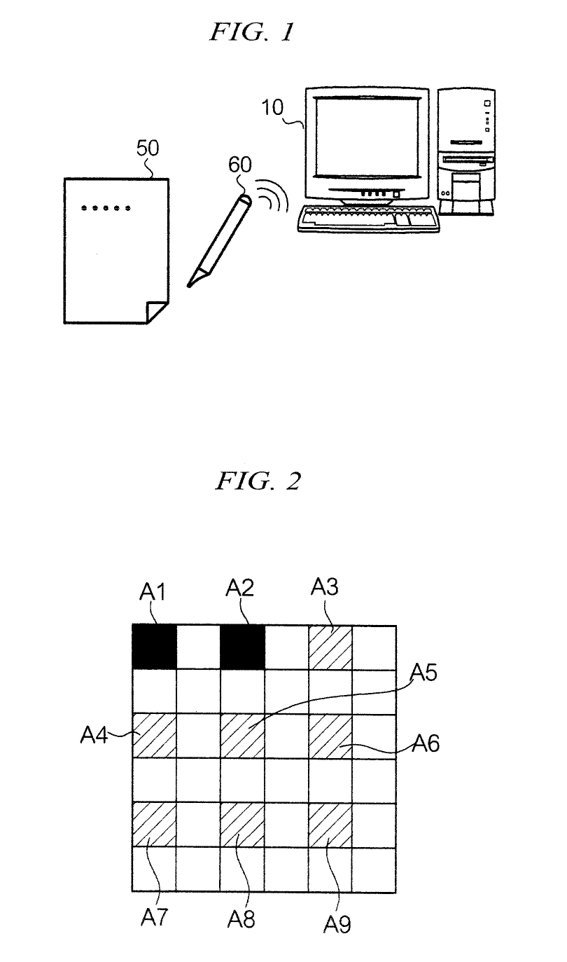

FIG. 1 shows an exemplary configuration of a system according to a first exemplary embodiment of the present invention. In FIG. 1, a digital pen 60 is an exemplary image reading apparatus provided with a function of writing characters, graphics and the like on a medium 50 such as paper, and a function of reading a code pattern image (a target image, an image to be read) formed on the medium 50. An information processing apparatus 10 is an exemplary writing information generating apparatus The information processing apparatus 10 is a personal computer, for example, and generates writing information representing written content according to signals output from the digital pen 60.

The code pattern image formed on the medium 50 is an image obtained by encoding identification information identifying the medium 50 and position information representing coordinate positions on the medium 50 to create an image. Here, an exemplary code pattern image formed on the medium 50 will be described with reference to FIG. 2. FIG. 2 shows an exemplary code pattern image formed on the medium 50. The code pattern image represents the abovementioned identification information and position information by the mutual positional relation of multiple dot images. Areas A1 to A9 are predetermined as areas in which these dot images can be formed. In the example shown in FIG. 2, the black areas A1 and A2 show areas in which dot images are formed, and the shaded areas A3 to A9 show areas in which dot images are not formed. The identification information and the position information are expressed by which areas the dot images are formed in. This code pattern image is formed over the entire medium 50 by an electrophotographic image forming apparatus (not shown) such as a printer, for example. The digital pen 60 reads the code pattern image, and detects the position of a pen tip 69a of the digital pen 60 by analyzing the read code pattern image.

Apart from the abovementioned code pattern image, an image representing a document, graphics or the like aimed at conveying information to a person may be formed on the medium 50. Hereinafter, this image will be called a “document image”, but includes images such as pictures, photographs and graphics, as well as other images, rather than being limited to an image representing a document that includes text. The image forming apparatus performs image forming using K (black) toner when forming a code pattern image, and performs image forming using C (cyan), M (magenta) and Y (yellow) toner when forming a document image. The document image and the code pattern image are formed one on top of the other on the medium 50. The digital pen 60 can be set so as to selectively read only the code pattern image, by respectively forming the code pattern image and the document image using materials with different spectral reflection characteristics.

Note that the “medium” in the present exemplary embodiment may be a plastic sheet such as an OHP (Over Head Projector) sheet, for example, or a sheet of another material, rather than being limited to so-called paper. The “medium” may also be so-called digital paper whose display content is electrically rewritable. In short, the medium 50 need only have at least a code pattern image formed thereon by an image forming apparatus or the like.

The digital pen 60 is both a writing instrument that has a function of writing characters, graphics and the like on the medium 50, and a image reading apparatus that reads the code pattern image formed on the medium 50. The digital pen 60 transmits information showing the code pattern image read from the medium 50 to the information processing apparatus 10.

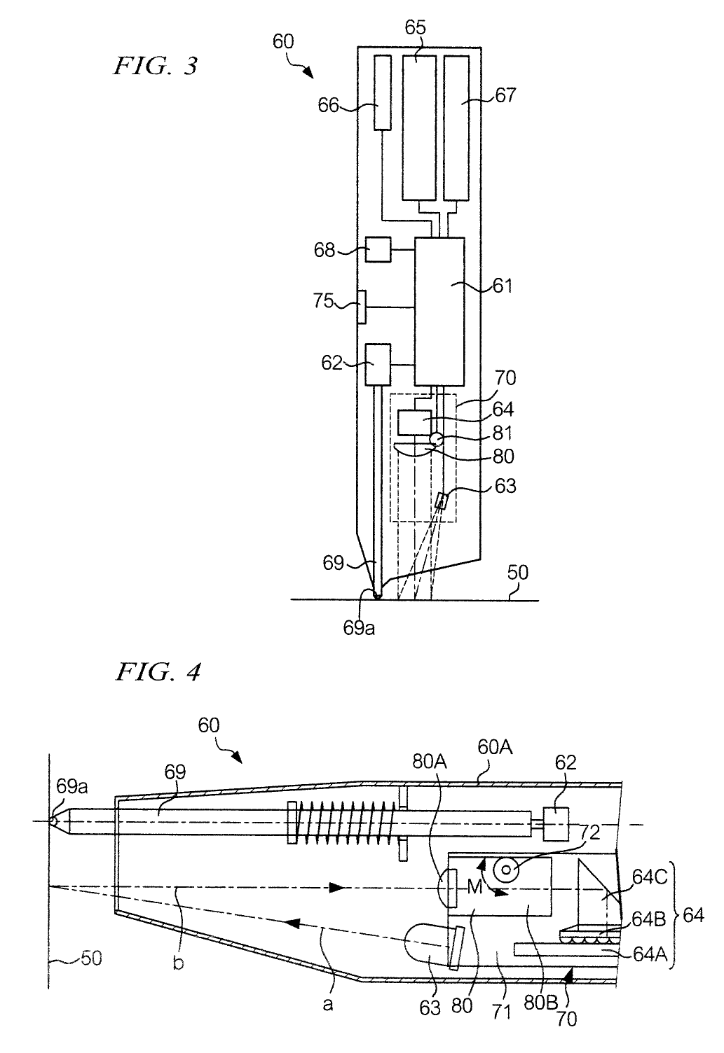

Next, an exemplary functional configuration of the digital pen 60 will be described with reference to the drawings. FIG. 3 is a functional block diagram schematically showing the functions of the digital pen 60. In FIG. 3, a controller 61 is an example of a controller that controls the operation of an element of the digital pen 60. A pressure sensor 62 is an example of a detecting unit that detects a track of a writing operation by the digital pen 60, based on pressure applied to the pen holder 69. An optics unit 70 includes an irradiating unit 63, an imaging unit 80, and an image sensing unit 64. The irradiating unit 63 is an exemplary irradiating unit that is a near-infrared LED, for example, and irradiates near-infrared light onto the medium 50. The imaging unit 80 is an exemplary imaging unit that images on the image sensing unit 64 in response to the image formed on the medium 50, according to the reflected light reflected by the medium 50. The image sensing unit 64 is an exemplary sensing unit that acquires an signal showing the image formed on the medium 50, according to the reflected light of the near-infrared light irradiated from the irradiating unit 63.

An information memory 65 is a storage that stores identification information and position information. A communication unit 66 is an example of a communication unit that controls communication with an external device. A battery 67 is an example of a rechargeable power supply unit that supplies power for driving the digital pen 60. A pen ID memory 68 is a storage that stores identification information (pen ID) of the digital pen 60. The pen holder 69 is a so-called penholder, and the front end portion of the pen holder 69 forms the pen tip 69a. The pen tip 69a is an example of a pointing part that points a position on the medium 50 having the code pattern image (target image, image to be read) formed thereon, when a writing operation is performed by a user. The irradiating unit 63 irradiates light in an irradiation range predetermined with respect to the position on the medium 50 pointed by the pen tip 69a, when a writing operation is performed by the user. In FIG. 3, for the sake of simplicity, only the central beam of light irradiated from the irradiating unit 63 is illustrated, but the light is actually irradiated in a diffused state. A switch 75 is an example of a switching unit that switches various settings. These units are connected to the controller 61. Further, a swing actuator 81 for swinging the imaging unit 80 is connected to the controller 61. Here, “the imaging unit 80 swings” denotes changing the position or direction of the imaging unit 80.

Next, exemplary configurations of the pen holder 69 and the optics unit 70 will be described with reference to the drawings. FIG. 4 is a cross-sectional view showing a schematic configuration of the digital pen 60. The pen holder 69 is provided inside a pen body 60A that forms a casing of the digital pen 60. The pressure sensor 62 is disposed at the rear end side of the pen holder 69. The pen holder 69 is movable toward the rear end side by force applied to the pen tip 69a, and the pressure sensor 62 detects that force is applied to the pen tip 69a by detecting that the pen holder 69 has moved due to writing pressure.

The optics unit 70 is housed in the pen body 60A, at the rear end side of the pen holder 69. This optics unit 70 includes the irradiating unit 63, the imaging unit 80 rotatably supported by a rotation axis 72 of a unit case 71, and the image sensing unit 64 which converts the image of the image on the medium 50 formed by the imaging unit 80 using reflected light to electrical signals, and the irradiating unit 63 and the image sensing unit 64 are fixed to the unit case 71. Also, the rotation axis 72 extends in a direction orthogonal to the optical axis of light irradiated from the irradiating unit 63 toward the medium. Here, for the sake of simplicity, the optical axis of light irradiated from the irradiating unit 63 will be referred to an irradiation axis a, and the central axis of the image forming optical system of the imaging unit 80 will be referred to a light receiving axis b. The direction of the light receiving axis b referred to here is basically in the direction that a light receiving surface faces, and, typically, is in a direction that connects the center of the light receiving surface with the center of an area (hereinafter, called the imaging range) on the medium 50 whose image is formed by the imaging unit 80 and imaged by the image sensing unit 64.

The image sensing unit 64 includes a substrate 64A having electronic components mounted thereon, an image sensing device 64B mounted on this substrate 64A, and a prism 64C that reflects and guides the light whose image is formed by the imaging unit 80 to the image sensing device 64B. The image sensing device 64B acquires the code pattern image based on the reflected light of the surface to be read whose image is formed by the imaging unit 80, and outputs signals representing the imaged code pattern image. Here, the image sensing device 64B includes a CMOS (Complementary Metal Oxide Semiconductor) image sensor having sensitivity in a near-infrared region, and a global shutter CMOS image sensor that is able to generate image signals obtained by acquiring all pixels at the same timing is used. The image sensing device 64B acquires an image in accordance with an image capture cycle (frame rate) of around 70 to 100 fps (frames per second). Here, the irradiating unit 63 is configured so as to pulse in synchronization with the image capture cycle to the image sensing device 64B, in order to suppress power consumption. Note that a CMOS image sensor is used here as the image sensing device, but the image sensing device is not limited to a CMOS image sensor. Another image sensing device such as a CCD (Charge Coupled Device) may be used.

The imaging unit 80 has a convex lens 80A constituting the light receiving surface, and a lens supporting member 80B that supports the convex lens 80A. The imaging unit 80 is an exemplary imaging unit that forms an image of the image on the medium 50 on the image sensing unit 64 according to the reflected light. The lens supporting member 80B is rotatably supported by the rotation axis 72 of the optics unit 70. The swing actuator 81 swings the lens supporting member 80B in the direction of arrow M. The swing actuator 81 is constituted by a combination of a rotational motor and a swing slider mechanism, or a linear actuator or the like. An exemplary changing unit is constituted by the swing actuator 81 and the rotation axis 72.

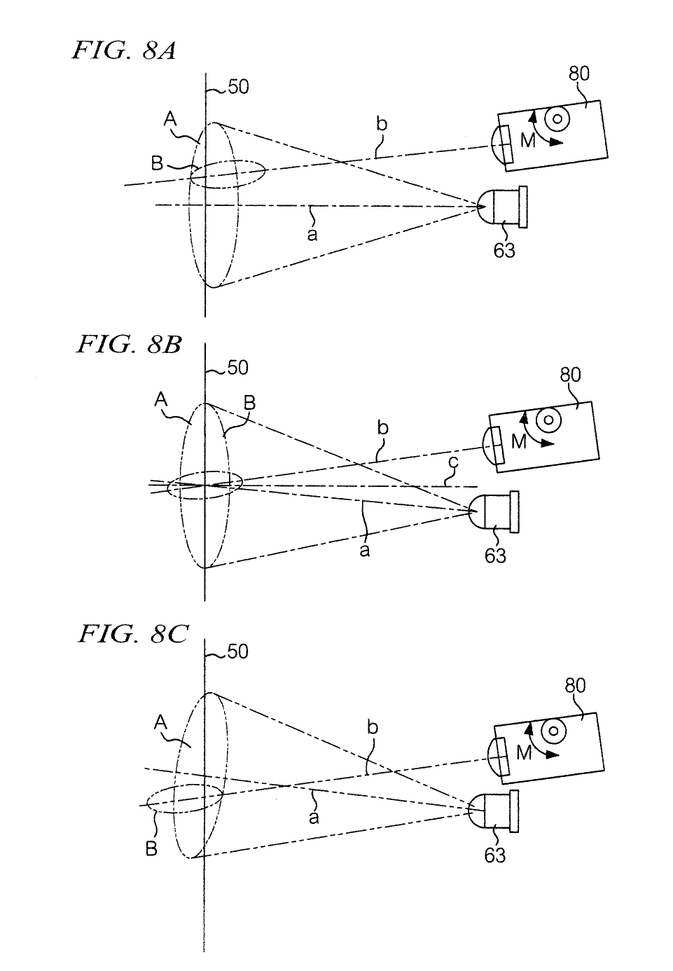

By swinging the imaging unit 80, the digital pen 60 changes both the image acquiring range on the medium 50 and the focal length, as shown in FIGS. 8A to 8C. FIGS. 8A to 8C schematically show an irradiation range A of light irradiated toward the medium 50 by the irradiating unit 63, and an image acquiring range B of the imaging unit 80. The irradiation range A shows a range of the light irradiated from the irradiating unit 63, and the image acquiring range B is a range that includes the focal length (so-called depth of field) of the imaging unit 80, that is, a range within which light is received in a state where the image is focused. Accordingly, the direction of the light receiving axis b will be in a longitudinal direction of the casing of the digital pen 60.

FIG. 8B shows a state of specular reflection that arises in the case where a normal line c with respect to the medium 50 coincides, at the point where the irradiation axis a meets the light receiving axis b, with a central axis that bisects the angle between the axes. In this case, reading errors often occur, since the reflected light received by the imaging unit 80 will be a specular component. In contrast, in FIG. 8A, the image acquiring range B moves to the right compared with the image acquiring range B of FIG. 8B, and in FIG. 8C, the image acquiring range B moves to the left compared with the image acquiring range B of FIG. 8B. Also, with FIG. 8A and FIG. 8C, reading errors decrease and reading accuracy improves, since the diffuse component in the reflected light received by the imaging unit 80 increases. The increase of the diffuse component is caused by deviation of the image acquiring range B from the irradiation axis a.

Here, with FIG. 8A and FIG. 8C, the imaging unit 80 will receive light reflected at a position that deviates from the position at which the focal length coincides with the image to be read on the medium 50 (just-focus position), and whichever of FIG. 8A or FIG. 8C approaching just focus is selected and used in the reading.

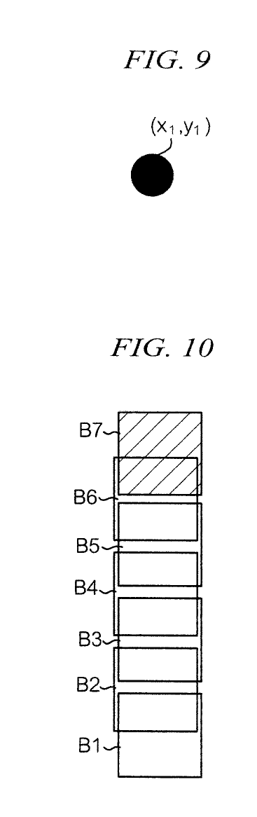

Next, an exemplary operation in the case where a user writes the dot illustrated in FIG. 9 on the medium 50 using the digital pen 60 will be described. The user points a position (x₁, y₁) on the medium 50 with the digital pen 60, and presses the pen tip 69a against the medium 50. The pressure sensor 62 connected to the pen holder 69 thereby detects the writing operation, and the digital pen 60 starts a process of reading identification information and position information. At this time, the digital pen 60 starts swinging the imaging unit 80 in the direction of arrow M due to the pressing down operation of the pen tip 69a by the user.

FIG. 10 shows an exemplary transition of the image acquiring range B by the imaging unit 80. FIG. 10 schematically shows a shift of the image acquiring range B that corresponds to the writing operation shown in FIG. 9. Note that in FIG. 10, the number of image acquiring ranges B of the optics unit 70 is shown at a lesser number than the number actually imaged, in order to avoid complicating the figure. The imaging unit 80 swings and the image acquiring range of the imaging unit 80 gradually varies from area B1 to area B7, in conjunction with the operation of the pen tip 69a being pressed down by the user at the position (x₁, y₁) shown in FIG. 9.

With a conventional digital pen, the code pattern image cannot be correctly read and a reading error occurs when the imaging unit receives a large specular component in the case where a certain point on the medium 50 is pointed. As a result, information on the writing operation is deficient.

In contrast, with the imaging unit 80 of the digital pen 60 of the present exemplary embodiment, imaging is performed in multiple image acquiring ranges at multiple different light receiving angles, even in the case where the user points a certain point on the medium 50 (see areas B1 to B7 in FIG. 10). At this time, as mentioned above, the angle of intersection formed by the irradiation axis a of the irradiating unit 63 and the light receiving axis b of the imaging unit 80 with respect to the medium 50 differs for each of areas B1, B2, . . . , and B7. Accordingly, by choosing an image approaching just focus from these images of the image to be read, reading errors can be reduced and reading accuracy can be improved, even in the case where a large specular component is received.

Next, in the case where a continuous line is drawn on the medium 50, image acquiring ranges are formed while overlapping like the waveform of a triangular wave in the direction in which the pen holder 69 moves. By choosing an image approaching just focus, out of the images imaged in these image acquiring ranges, reading errors can be reduced and reading accuracy can be improved, even in the case where a large specular component is received.

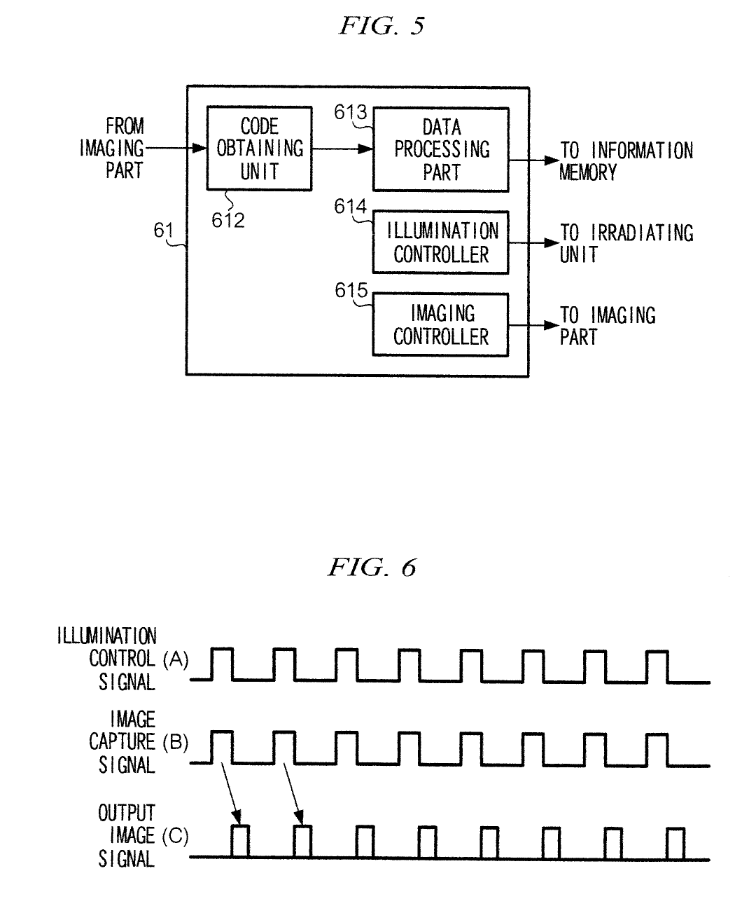

Next, the functional configuration of the controller 61 will be described with reference to FIG. 5. FIG. 5 is a functional block diagram showing the functions of the controller 61. In FIG. 5, a code obtaining unit 612 obtains the code pattern image from the signals output from the image sensing unit 64 (signals representing imaged images). A data processing unit 613 extracts the identification information and the position information from the code pattern image detected by the code obtaining unit 612. An illumination controller 614 transmits illumination control signals for causing the irradiating unit 63 to pulse to the irradiating unit 63, and causes the irradiating unit 63 to pulse. An imaging controller 615 supplies image capture signals that are synchronized with the illumination control signals transmitted to the irradiating unit 63 to the image sensing unit 64.

Further, a schematic of the operation of the controller 61 in the digital pen 60 will be described. FIG. 6 is a timing chart showing output relating to the illumination control signals controlling the pulsing of the irradiating unit 63, the image capture signals to the image sensing unit 64, and output image signals. When writing by the digital pen 60 is started, the pressure sensor 62 connected to the pen holder 69 detects the writing operation. The controller 61 thereby starts the process of reading identification information and position information.

Firstly, the illumination controller 614 of the controller 61 transmits illumination control signals ((A) in FIG. 6) for causing the irradiating unit 63 to pulse to the irradiating unit 63, and causes the irradiating unit 63 to pulse.

The image sensing unit 64 images the image on the medium 50 in synchronization with the image capture signals ((B) in FIG. 6). At this time, the irradiating unit 63 pulses in synchronization with the image capture signals to the image sensing unit 64. The image sensing unit 64 images the image on the medium 50 illuminated by the pulsing irradiating unit 63. Thus, in the image sensing unit 64, image signals (output image signals: (C) in FIG. 6) relating to the image on the medium 50 illuminated by the irradiating unit 63 are generated in order.

The output image signals sequentially acquired by the image sensing unit 64 are sent to the code obtaining unit 612. The code obtaining unit 612, having received the output image signals, processes the output image signals, and obtains the code pattern image from the images imaged by the image sensing unit 64. The code pattern image acquired by the code obtaining unit 612 is sent to the data processing unit 613. The data processing unit 613, having received the code pattern image, decodes the code pattern image, and acquires the identification information and the position information embedded in the code pattern image.

### 1-2. Operation

Next, the operation of the digital pen 60 according to the present exemplary embodiment will be described. When the user starts writing with the digital pen 60, the pressure sensor 62 connected to the pen holder 69 detects the writing operation.

In this exemplary operation, an exemplary operation in the case where the user writes the dot illustrated in FIG. 9 on the medium 50 using the digital pen 60 will be described. The user points the position (x₁, y₁) on the medium 50 with the digital pen 60, that is, the user presses the pen tip 69a against the medium 50. The pressure sensor 62 connected to the pen holder 69 thereby detects the writing operation, and the controller 61 starts the process of reading identification information and position information.

Firstly, the illumination controller 614 transmits illumination control signals for causing the irradiating unit 63 to pulse to the irradiating unit 63, and causes the irradiating unit 63 to pulse. Also, the imaging controller 615 of the digital pen 60 supplies image capture signals that are synchronized with the illumination control signals transmitted to the irradiating unit 63 to the image sensing unit 64. The image sensing unit 64 images the code pattern image based on the reflected light whose image is formed by the imaging unit 80, in response to the image capture signals supplied from the imaging controller 615. The image sensing unit 64 outputs output image signals representing the imaged code pattern Image to the code obtaining unit 612.

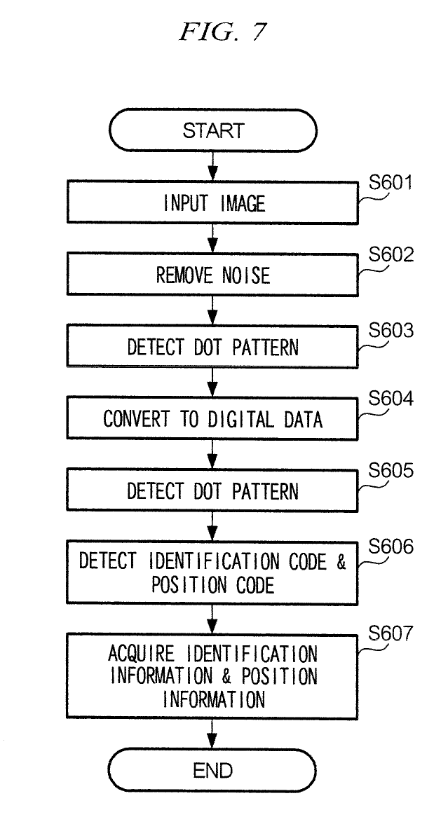

Next, the operations of the code obtaining unit 612 and the data processing unit 613 will be described with reference to the flowchart shown in FIG. 7. The output image signals representing the image on the medium 50 are input to the code obtaining unit 612 from the image sensing unit 64 (step S601). The code obtaining unit 612 performs a process for removing noise included in the output image signals (step S602). Here, noise includes noise generated by electronic circuitry and variation in CMOS sensitivity. The process performed in order to remove noise is determined according to the characteristics of the imaging system of the digital pen 60. For example, a gradation process or a sharpening process such as unsharp masking is applied. Next, the code obtaining unit 612 obtains the dot pattern (position of the dot images) from the image (step S603). Also, the code obtaining unit 612 converts the detected dot pattern to digital data on a two-dimensional array (step S604). For example, the code obtaining unit 612 converts the detected dot pattern into data such that positions with a dot are “1” and positions without a dot are “0” on the two-dimensional array. This digital data on a two-dimensional array (code pattern image) is then transferred from the code obtaining unit 612 to the data processing unit 613.

The data processing unit 613 detects the dot pattern composed of the combination of two dots shown in FIG. 2, from the transferred code pattern image (step S605). For example, the data processing unit 613 is able to detect the dot pattern, by moving the boundary positions of a block corresponding to the dot pattern over the two-dimensional array, and detecting the boundary positions at which the number of dots included in the block is two. When a dot pattern is thus detected, the data processing unit 613 detects an identification code and a position code, based on the type of dot pattern (step 606). Subsequently, the data processing unit 613 decodes the identification code to acquire identification information, and decodes the position code to acquire position information (step S607. In the process shown FIG. 7, the case where a dot pattern is not detected from an imaged image and the digital pen 60 is unable to acquire identification information and position information (i.e., a reading error) arises, in the case where the amount of light received by the image sensing unit 64 is too little or conversely in the case where the amount of received light is too much. In the case where identification information and position information cannot thus be acquired, the data processing unit 613 acquires information showing reading failure, instead of identification information and position information.

The digital pen 60 transmits the identification information and the position information acquired by the process of FIG. 7 to the information processing apparatus 10. At this time, the digital pen 60 transmits the information showing reading failure to the information processing apparatus 10, in the case where the reading of identification information and position information fails. The information processing apparatus 10 receives the identification information and the position information from the digital pen 60, and generates writing information based on the received position information. The information processing apparatus 10, in the case where information showing a reading error is received from the digital pen 60, generates writing information by interpolating or the like using identification information and position information received previously or subsequently.

### 1-3. Exemplary Operation

Next, an example of a specific operation of this exemplary embodiment will be described with reference to the drawings. With the digital pen 60 according to the present exemplary embodiment, the operation of swinging the imaging unit 80 is performed by the swing actuator 81. As shown in the schematic diagrams of FIGS. 8A to 8C, the image acquiring range B of the imaging unit 80 swings within the irradiation range A of the irradiating unit 63. Then, by reading the reflected light at a position that deviates from the position at which the focal length coincides with the image to be read on the medium 50 (just focus) by the image sensing unit 64, reading errors are reduced, and the reading accuracy of the image to be read improves.

Incidentally, an auto focus mechanism is normally employed in the imaging unit, in order to enhance imaging efficiency in a digital pen. There are auto focus mechanisms that adjust the focal length with respect to the medium 50 (focusing), by changing the distance between multiple lenses constituting the imaging unit along the light receiving axis.

The digital pen is normally used in state of being tilted at certain angle, because the detection operation in the optics unit is started by a writing operation being performed by the user. However, the digital pen may be used in a state of being held orthogonal to (or vertically) the medium, depending on the writing mannerisms of the user, such as the case where the user writes while checking what he or she has written, as in the case of a left-handed user.

In such a case, the pen holder 69 and the optics unit 70 in the digital pen are arranged coaxially. Consequently, as shown in FIG. 8B, the normal with respect to the medium 50 may coincide, at the point at which the irradiation axis a meets the light receiving axis b, with a central axis that bisects the angle between the axes. In such a case, the reflected light received by the imaging unit 80 will be a specular component, and reading errors whereby the code pattern image cannot be correctly read may frequently occur.

Moreover, with the aforementioned auto focus mechanism, reading errors are unavoidable if auto focus (focusing) is performed at a position from which a specular component is received, since focusing is performed by moving the lenses along the light receiving axis.

In contrast, with the digital pen 60 according to the present exemplary embodiment, reduction in reading errors is achieved by more reflected light of a diffuse component than reflected light of a specular component being received by the imaging unit 80, since the angle formed by the irradiation axis a and the light receiving axis b is changed by swinging the imaging unit 80.

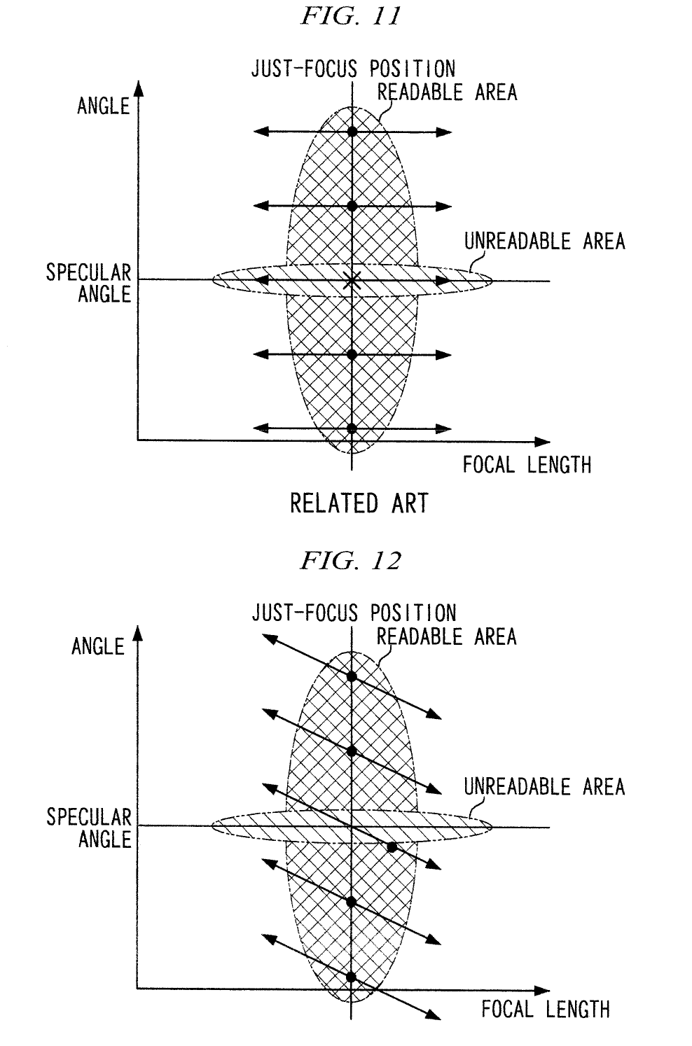

Specific examples are shown in FIG. 11 and FIG. 12. FIG. 11 and FIG. 12 schematically show a readable area and an unreadable area, with regard to the focal length of the imaging unit 80 and the angle of the light receiving axis b with respect to the medium 50.

The horizontal axis shows the focal length which varies as a result of the site within the optics unit 70 being moved. The vertical axis shows the angle of the digital pen 60 with respect to the medium 50.

The specular angle is the angle at which the normal with respect to the medium 50 coincides, at the point where the irradiation axis a meets the light receiving axis b, with a central axis that bisects the angle between the axes.

FIG. 11 is a characteristic line diagram showing the characteristics of focusing (movement of focal length) by an auto focus mechanism performed by moving the aforementioned lenses in the imaging unit along the light receiving axis b. The bidirectional lines extending laterally show the range of the focusing performed for each angle. Thus, the bidirectional lines extend in the lateral direction, since it is only the focal length that can be changed by this auto focus mechanism. Further, at the specular angle, the image that is imaged using the reflected light will be unreadable, since the focal length only moves within the unreadable area with this auto focus mechanism.

FIG. 12 is a characteristic line diagram showing focusing (movement of focal length) characteristics when the imaging unit 80 of the digital pen 60 of the present exemplary embodiment is swung. Since the angle formed by the irradiation axis a and the light receiving axis b is changed by the swinging operation of the imaging unit 80, the focal length and the angle of the light receiving axis b with respect to the medium 50 will vary, following the swinging operation of the imaging unit. The bidirectional lines are thus drawn at an oblique angle. Further, in the case where the specular angle is reached, reflected light received in a readable area that deviates from the position where the focal length coincides with the image to be read on the medium 50 (just-focus position) is imaged with the image sensing unit 64. With the imaging unit 80 and the image sensing unit 64, a readable image can be acquired, and reading errors in the image sensing unit 64 can be reduced as a result.

### 2. Second Exemplary Embodiment

Next, a second exemplary embodiment of the present invention will be described.

### 2-1. Configuration

In the configuration of the system according to this exemplary embodiment, the configuration of the digital pen differs from the configuration of the system according to the abovementioned first exemplary embodiment. The other constituent elements are similar to those of the abovementioned first exemplary embodiment. Thus, in the following description, the same reference numerals are given to constituent elements that are similar to the abovementioned first exemplary embodiment, and description thereof will be appropriately omitted.

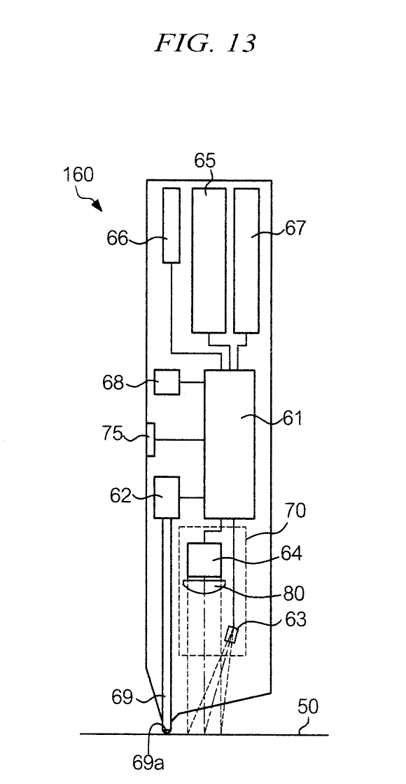

Next, an exemplary functional configuration of a digital pen 160 according to the present exemplary embodiment will be described with reference to the drawings. FIG. 13 is a block diagram schematically showing an exemplary functional configuration of the digital pen 160. The configuration of the digital pen 160 shown in FIG. 13 differs from the configuration of the digital pen 60 shown in FIG. 3 in the abovementioned first exemplary embodiment in that the digital pen 160 does not have the swing actuator 81. The remaining configuration is similar to that of the abovementioned first exemplary embodiment. Thus, in the following description, the same reference numerals are given to constituent elements that are similar to the abovementioned first exemplary embodiment, and description thereof will be appropriately omitted.

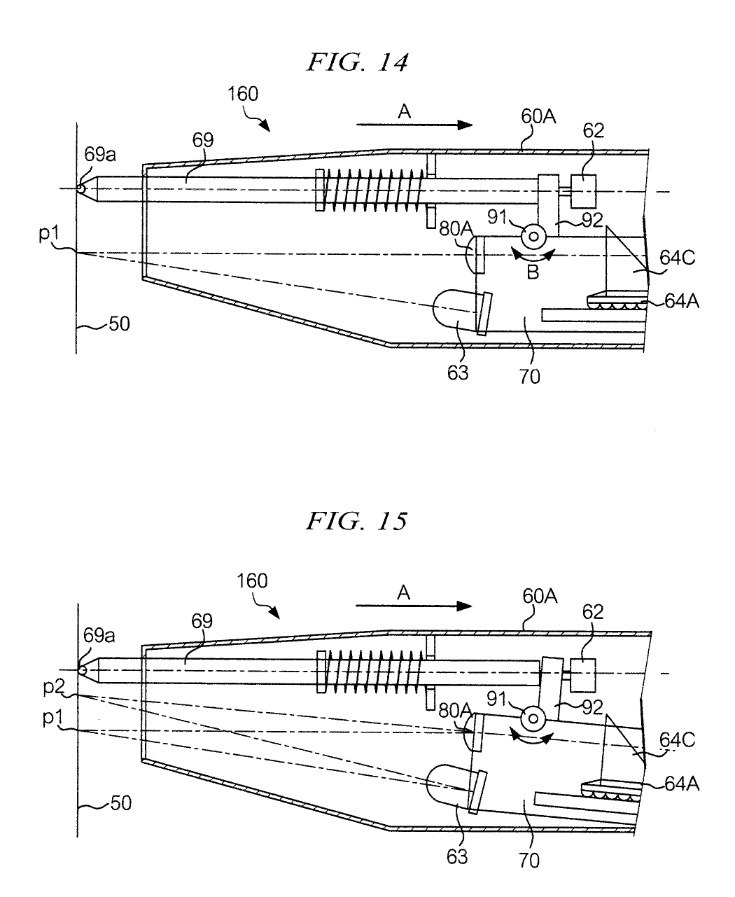

Next, exemplary configurations of the pen holder 69 and the optics unit 70 will be described with reference to the drawings. FIG. 14 is an exemplary cross-sectional side view of the digital pen 160.

In FIG. 14, the pen holder 69 is provided movably in the direction of arrow A by force applied to the pen tip 69a. A rotation axis 91 rotatably supports the optics unit 70. A rotation end 92 is provided fixedly to the optics unit 70. The rotation end 92 is provided in a position between the pen holder 69 and the pressure sensor 62. When force is applied to the pen tip 69a, the pen holder 69 moves in the direction of arrow A, and the force applied to the pen nip 69a is applied to the rotation end 92 by this movement. As a result of the rotation end 92 being pushed by the pen holder 69, the rotation end 92 rotates around the rotation axis 91. The entire optics unit 70 rotates following the rotation of the rotation end 92. Also, the pressure sensor 62 is pushed by the rotation end 92 rotating, and the pressure on the pen tip 69a is thereby detected by the pressure sensor 62.

FIG. 15 shows a state where the pen holder 69 has moved in the direction of arrow A as a result of force being applied to the pen tip 69a. As shown in FIG. 15, the force applied to the pen tip 69a is applied to the optics unit 70 by the pen holder 69, and the optics unit 70 rotates around the rotation axis 91 as a result of the force applied to the pen tip 69a being applied to the optics unit 70. As a result of the optics unit 70 rotating, the position on the medium 50 irradiated with light by the irradiating unit 63 and the position on the medium 50 at which the reflected light received by a light receiving part 641 is reflected (see position p1 in FIG. 14, position p2 in FIG. 15) vary. That is, as shown in FIG. 14 and FIG. 15, the angle at which the optical axis of the irradiating unit 63 intersects the optical axis of the light receiving part 641 (dash-dotted lines in FIGS. 14, 15) with respect to the surface of the medium 50 (hereafter, medium surface) on which the image is formed varies according to the force applied to the pen tip 69a. The rotation axis 91 and the pen holder 69 thus function as a changing unit that varies the position or direction of the optics unit 70 according to the force applied to the pen tip 69a, and changes the position on the medium 50 irradiated with light by the optics unit 70, and the position on the medium 50 at which the reflected light received by the optics unit 70 is reflected.

The rotation angle of the optics unit 70 varies in a range between the angle shown in FIG. 14 and the angle shown in FIG. 15 according to the force applied to the pen tip 69a. As shown in FIG. 14 and FIG. 15, the amount of movement of the pen holder 69 increases the greater the force applied to the pen tip 69a, and the amount of rotation of the optics unit 70 increases. That is, the amount of variation in the position or direction of the optics unit 70 increases the greater the force applied to the pen tip 69a.

### 2-2. Operation

Next, the operation of this exemplary embodiment will be described. When writing by the digital pen 160 is started, the pressure sensor 62 connected to the pen holder 69 detects the writing operation. The controller 61 thereby starts the process of reading identification information and position information. Firstly, the illumination controller 614 transmits illumination control signals for causing the irradiating unit 63 to pulse to the irradiating unit 63, and causes the irradiating unit 63 to pulse. Also, the imaging controller 615 of the digital pen 160 supplies image capture signals that are synchronized with the illumination control signals transmitted to the irradiating unit 63 to the image sensing unit 64. The image sensing unit 64, in response to the image capture signals supplied from the imaging controller 615, images the code pattern image based on the reflected light received by the light receiving part 641, and outputs output image signals representing the imaged code pattern image to the code obtaining unit 612. Note that since the operations performed by the code obtaining unit 612 and the data processing unit 613 are similar to the operations described using FIG. 7 in the abovementioned first exemplary embodiment, description thereof will be omitted here.

### 2-3. Exemplary Operation 1

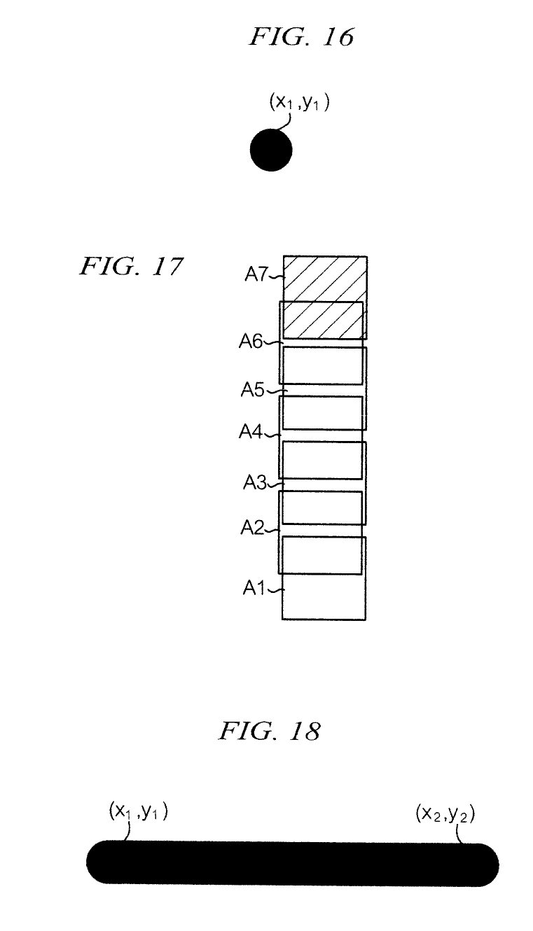

Next, an example of a specific operation of this exemplary embodiment will be described with reference to the drawings. In this exemplary operation, an exemplary operation in the case where the user writes the dot illustrated in FIG. 16 on the medium 50 using the digital pen 160 will be described. The user points the position (x₁, y₁) on the medium 50 with the digital pen 160, and presses the pen tip 69a against the medium 50. The pressure sensor 62 connected to the pen holder 69 thereby detects the writing operation, and starts the process of reading identification information and position information. At this time, the optics unit 70 rotates in conjunction with the pressing down operation of the pen tip 69a by the user. Thus, as illustrated in FIG. 14 and FIG. 15, the angle of intersection and the point of intersection of the optical axis of the irradiating unit 63 and the optical axis of the light receiving part 641 with respect to the medium 50 gradually vary in conjunction with the pressing down operation of the pen tip 69a by the user.

FIG. 17 shows an exemplary transition of the image acquiring range by the optics unit 70. FIG. 17 corresponds to the writing operation shown in FIG. 16. Note that in FIG. 17, the number of image acquiring ranges of the optics unit 70 is shown at a lesser number than the number actually imaged, in order to avoid complicating the figure. The optics unit 70 rotates and the image acquiring range of the optics unit 70 gradually varies from area A1 to area A7, in conjunction with the operation of the pen tip 69a being pressed by the user at the position (x₁, y₁) shown in FIG. 16.

Incidentally, when writing is performed on the medium 50 with the digital pen 160, the angle between the digital pen 160 and the medium 50 varies successively following the writing operation. At this time, as shown in FIG. 20, in a conventional digital pen 260, the angle between the digital pen and the medium may reach a state approaching 90 degrees. With a digital pen, because an elongated shape like a pen constituting a normal writing instrument is desired, an irradiating unit 163 and a light receiving part 180A must be disposed in positions in relative proximity to one another in a direction orthogonal to the longitudinal direction of the digital pen. Because of such configuration restrictions, a specular component is mainly received by the light receiving part 180A out of the reflected light of the light irradiated from the irradiating unit 163, as shown in FIG. 20, in a state where the angle between the digital pen and the medium approaches 90 degrees. At this time, depending on the type of toner that forms the code pattern image, reflected light that exceeds the maximum light receiving strength coverable by the light receiving part 180A may reach the light receiving part 180A due to the reflected light being too strong, and the code pattern image may not be able to be correctly read.

In particular, with the conventional digital pen, when the light receiving part 180A receives a large specular component in the case where a certain point on the medium 50 is pointed, the code pattern image is not read correctly and the reading of information fails, resulting in information on the writing operation being deficient. In contract, because the optics unit 70 of the digital pen 160 of the present exemplary embodiment rotates according to the force applied to the pen tip 69a, imaging is performed at multiple different imaging angles in the time period between the start and the end of the pen tip 69a being pressed down, even in the case where the user points a certain point on the medium 50 (see areas A1 to A7 in FIG. 17). At this time, as mentioned above, because the angle of intersection of the optical axis of the irradiating unit 63 and the optical axis of the light receiving part 641 with respect to the medium 50 differs for each of areas A1, A2, . . . , A7, image reading is performed at another timing, even in the case where reading fails at a timing between the start and the end of the pen tip 69a being pressed down. Specifically, in the example shown in FIG. 17, for example, even in the case where the light receiving part 641 receives a large specular component at an imaging angle corresponding to area A7 (area shown by shading) so that reading of the code pattern image fails, the code pattern image is read at another different imaging angle. Thus, in the present exemplary embodiment, a deficiency of information on the writing operation can be avoided, even in the case where the writing operation performed is only a touch operation of the pen tip 69a. Note that in this exemplary operation, an exemplary operation in the case where the dot shown in FIG. 16 is written on the medium 50 was described, but the present invention is not limited to this, and the digital pen 160 of the present exemplary embodiment is also effective in the case where a position on a display surface is merely designated, such as where a soft button is selected, for example.

### 2-4. Exemplary Operation 2

Next, another example of a specific operation of this exemplary embodiment will be described with reference to the drawings. In this exemplary operation, an exemplary operation in the case where the user writes the line illustrated in FIG. 18 on the medium 50 using the digital pen 160 will be described. Firstly, the user points the position (x₁, y₁) on the medium 50 with the digital pen 160, that is, the user presses the pen tip 69a against the medium 50. The pressure sensor 62 connected to the pen holder 69 thereby detects the writing operation, and starts the process of reading identification information and position information. At this time, the optics unit 70 rotates in conjunction with the pressing down operation of the pen tip 69a by the user. Thus, the angle of intersection and the point of intersection of the optical axis of the irradiating unit 63 and the optical axis of the light receiving part 641 with respect to the medium 50 gradually vary in conjunction with the pressing down operation of the pen tip 69a by the user.

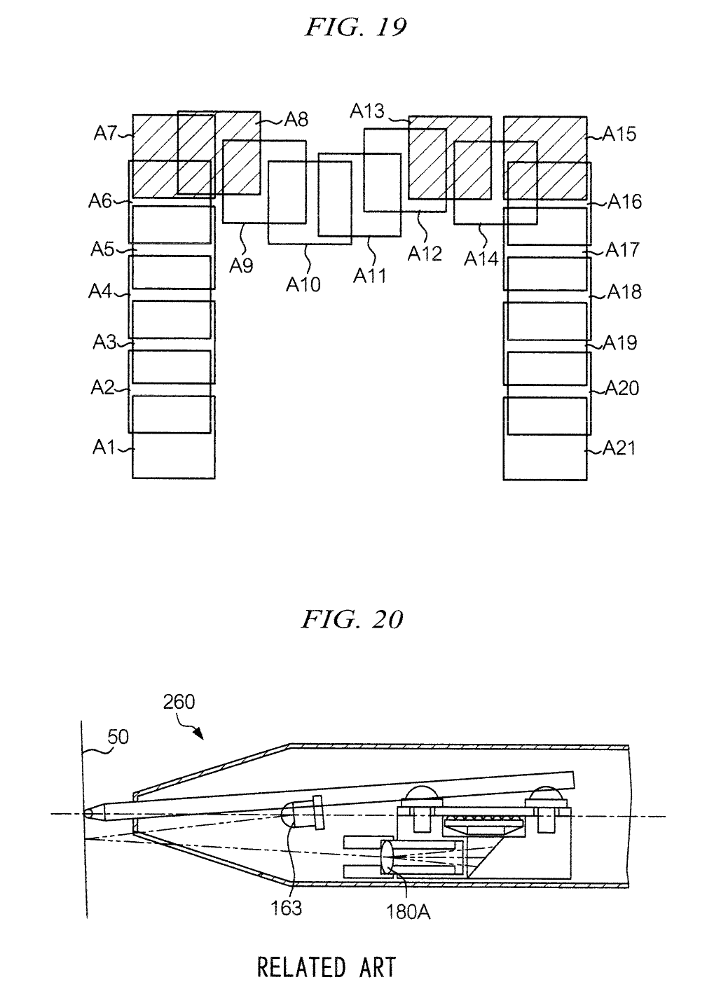

FIG. 19 shows an exemplary transition of the image acquiring range by the optics unit 70. FIG. 19 corresponds to the writing operation shown in FIG. 18. Note that in FIG. 19, the number of image acquiring ranges of the optics unit 70 is shown at a lesser number than the number actually imaged, in order to avoid complicating the figure. The optics unit 70 rotates and the image acquiring range of the optics unit 70 gradually moves from area A1 to area A7, in conjunction with the operation of the pen tip 69a being pressed down by the user at the position (x₁, y₁) shown in FIG. 18.

Next, the user moves the pen tip 69a from the position (x₁, y₁) to a position (x₂, y₂), while keeping the pen tip 69a pressed against the medium 50 (see FIG. 18). Following this movement of the pen tip 69a, the image acquiring range of the optics unit 70 moves from area A7 to area A15, as shown in FIG. 19. That is, following the movement of the pen tip 69a, the code pattern image from area A7 to area A15 is imaged in order, and position information and identification information are read according to the imaged code pattern image. Incidentally, it may be the case that when the user moves the pen tip 69a over the medium surface of the medium 50, the pressure applied to the pen tip 69a is not constant during the movement. Thus, it may be the case that the position of the imaging area of the optics unit 70 varies in a vertical direction of FIG. 19 according to the amount of force applied to the pen tip 69a, as illustrated in FIG. 19.

Once the pen tip 69a has been moved to the position (x₂, y₂), the user lifts the pen tip 69a from the medium 50. Following this operation, the pressure applied to the pen tip 69a gradually decreases. The pen holder 69 moves in the opposite direction to the direction of arrow A in FIG. 14 following the decrease in pressure applied to the pen tip 69a, and the optics unit 70 rotates following this movement. The image acquiring range of the optics unit 70 thereby gradually moves. In the example shown in FIG. 19, the image acquiring range of the optics unit 70 moves from area A15 to area A21, following the rotation of the optics unit 70.

Even in this exemplary operation, in may be the case that the light receiving part 641 receives a large specular component, and the code pattern image cannot be correctly read, depending on the angle between the digital pen 160 and the medium 50. However, because the optics unit 70 of the present exemplary embodiment rotates according to the pressure applied to the pen tip 69a, reading will be performed at other imaging angles, even if reading fails at one angle. Specifically, in the example shown in FIG. 19, for example, even in the case where reading fails in areas A7, A8, A13 and A15 (areas shown by shading), image reading is performed in other areas. In this case, the trajectory of the writing can be approximately specified, by linking the read information using a suitable interpolation method.

In particular, because reading is performed at the multiple imaging angles of area A1 to area A7 at the start position (x₁, y₁) of the writing, reading will be performed at other imaging angles, even if reading fails at one angle. Also, because reading is also performed at the multiple imaging angles of area A15 to area A21 at the end position (x₂, y₂) of the writing, reading will be performed at other imaging angles, even if reading fails at one reading angle. That is, position information will definitely be read at the start position (x₁, y₁) of the writing and the end position (x₂, y₂) of the writing. With the conventional digital pen, it may be the case that reading fails at the start position of the writing and the end position of the writing, in which case the accuracy of writing information may deteriorate. In contrast, with the digital pen 160 of the present exemplary embodiment, because position information will definitely be read at the start position of the writing and the end position of the writing, the accuracy of writing information increases in comparison with the related art. Also, because the imaging angle of the optics unit 70 varies according to the force applied to the pen tip 69a, even in positions between the start position of the writing and the end position of the writing, successive failure of information reading is reduced, and the accuracy of writing information increases, even in the case where the user moves the pen tip 69a while keeping the angle of the digital pen 160 constant.

### 3. Variations

Hereinabove, exemplary embodiments of the present invention were described, but the present invention is not limited to the abovementioned exemplary embodiments, and various other exemplary embodiments can be implemented. Examples of these will be shown hereinafter. Note that the following illustrative exemplary embodiments may be combined.

(1) In the aforementioned exemplary embodiments, a digital pen for writing characters, graphics and the like on a medium 50 was described, but the present invention is not limited to this, and the digital pen may, for example, be provided with a pointing device (mouse) function, or a stylus function of reading information (e.g., command information) recorded in correspondence with areas on a medium.

Note that in the exemplary operations of the exemplary embodiments, exemplary operations in the case where characters or the like are written on the medium 50 were described, but the present invention is not limited to these, and the digital pens 60 and 160 of the abovementioned exemplary embodiments are also effective in the case where a position on a display surface is merely designated, such as where a soft button provided on the medium 50 is selected, for example.

(2) In the aforementioned exemplary embodiments, a near-infrared LED that irradiates near-infrared light is used as the irradiating unit 63, but the irradiating unit 63 is not limited to this, and an LED having different characteristics may be used. In short, the irradiating unit 63 need only irradiate a light that enables the code pattern image formed on the medium 50 to be read with the reflected light thereof

(3) In the aforementioned exemplary embodiments, information that uniquely identifies the medium is used as identification information, but the identification information is not limited to this, and information that uniquely identifies the electronic document may be used as identification information, for example. In the case where information that uniquely identifies the medium is used, as in the abovementioned exemplary embodiments, different identification information is assigned to different media when multiple copies of the same electronic document are formed. In contrast, in the case where information that uniquely identifies the electronic document is used as identification information, the same identification information is assigned even to different media when the same electronic document is formed.

Also, in the aforementioned exemplary embodiments, a code pattern image representing position information and identification information is read, but the information represented by the code pattern image is not limited to position information or identification information, and may, for example, be information representing text data or a command, or an image representing only position information. In short, an image representing information of some sort need only be formed on the medium 50.

(4) In the aforementioned image forming apparatus, the code pattern image is formed using K toner. This is because K toner absorbs more infrared light than C, M or Y toner, and the code pattern image can be read in high contrast with the digital pens 60 and 160. However, the code pattern image can also be formed using a specialty toner. Here, a specialty toner includes, for example, an invisible toner with a maximum absorption rate in a visible light region (400 nm to 700 nm) of 7% or less, and an absorption rate in a near-infrared region (800 nm to 1000 nm, of 30% or more. Here, “visible” and “invisible” have nothing to do with whether the toner can be visually perceived. “Visible” and “invisible” are distinguished by whether an image formed on a medium can be perceived due to whether the toner has color developing properties attributed to the absorption of specific wavelengths in the visible light region. Further, a toner that has some color developing properties attributed to the absorption of specific wavelengths in the visible light region but is difficult to perceive with the human eye is also included as “invisible”. This invisible toner desirably has an average dispersion diameter in a range of 100 nm to 600 nm, in order to enhance the near-infrared light absorption capability necessary for mechanical reading of images.

Also, the image forming apparatus is not limited to an electrophotographic system, and may use any other system, such as an inkjet system.

(5) In the abovementioned second exemplary embodiment, the digital pen 60 includes the rotation axis 91 rotatably supporting the optics unit 70, and the pen holder 69 that applies the pressure applied to the pen tip 69a to the optics unit 70, and uses a mechanism whereby the optics unit 70 swings around the rotation axis 91 as a result of the pressure applied to the pen tip 69a. The mechanism that varies the position or direction of the optics unit 70 is not limited to this, and, for example, the digital pen 60 may be provided with a drive mechanism that varies the position or direction of the optics unit 70 using a motor or the like, and the controller 61 may control the drive mechanism so as to vary the position or direction of the optics unit 70 according to the pressure detected by the pressure sensor 62. Also, as another example, a mechanism that swings the optics unit 70 in a horizontal direction with respect to an axial direction of the pen holder 69 according to the pressure applied to the pen tip 69a may be provided in the digital pen 60, for example. Also, a mechanism that oscillates the optics unit 70 according to the pressure applied to the pen tip 69a may be provided, for example. In short, the digital pen 60 need only be provided with a mechanism that varies the position or direction of the optics unit 70 according to the pressure applied to the pen tip 69a, and changes the position on the medium 50 irradiated with light by the optics unit 70, and the position on the medium 50 at which reflected light received by the optics unit 70 is reflected. That is, the digital pen 60 need only be provided with a mechanism that varies the angle at which the optical axis of the irradiating unit 63 intersects the optical axis of the light receiving part 641 with respect to the medium 50, according to the force applied to the pen tip 69a.

(6) In the abovementioned second exemplary embodiment, the digital pen uses a mechanism whereby the amount of rotation of the optics unit 70 increases the greater the pressure applied to the pen tip 69a, but the present invention is not limited to this, and the digital pen may, for example, be configured to detect whether pressure is applied to the pen tip 69a, and change the position or direction of the optics unit 70 by only a predetermined amount in the case where pressure is detected. In short, the digital pen 160 need only be provided with a mechanism that varies the position or direction of the optics unit 70 according to pressure applied to the pen tip 69a.

(7) A computer program that is executed by the controller 61 of the digital pens 60 and 160 according to the aforementioned exemplary embodiments can be provided in a state of being stored on a computer-readable recording medium such as magnetic recording medium (magnetic tape, magnetic disk, etc.), an optical recording medium (optical disk, etc.), an magneto-optical recording medium, or a semiconductor memory. Further, the computer program can also be downloaded to the digital pens 60 and 160 via a network such as the Internet. Note that various devices other than a CPU can be applied as a controller that performs the abovementioned control, and a dedicated processor may be used, for example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading apparatus comprising:
a pointing part that points a position on a medium on which a target image is formed, the target image being an image to be read;
an irradiating unit that irradiates light onto the position pointed by the pointing part;
an imaging unit that images light reflected from the medium irradiated with the light;
a sensing unit that acquires a signal representing the target image in response to the light imaged by the imaging unit; and
a changing unit that changes an direction or a position of the imaging unit.

2. The image reading apparatus according to claim 1, wherein the irradiating unit irradiates the light in an irradiation range that is predetermined with respect to the position on the medium pointed by the pointing part.

3. The image reading apparatus according to claim 2, wherein the changing unit includes:
a rotation axis that rotatably supports the imaging unit; and
a swinging unit that swings the imaging unit in a predetermined range around the rotation axis.

4. The image reading apparatus according to claim 1, wherein the changing unit changes the direction or the position of the irradiating unit and the imaging unit, according to an amount of variation in a position of the pointing part with respect to a body of the image reading apparatus, so as to change the position on the medium irradiated with light by the irradiating unit and the position on the medium at which the reflected light received by the imaging unit is reflected.

5. The image reading apparatus according to claim 4, wherein the changing unit increases the amount of variation in the position or the direction of the irradiating unit and the imaging unit, the greater the amount of variation in the position of the pointing part with respect to the body of the image reading apparatus.

6. The image reading apparatus according to claim 4, wherein
the changing unit includes:
a rotation axis rotatably supporting the irradiating unit and the imaging unit; and
a member that applies a force applied to the pointing part to the irradiating unit and the imaging unit, and
the irradiating unit and the imaging unit rotate around the rotation axis as a result of the force applied to the pointing part being applied to the irradiating unit and the imaging unit.

7. A reading method comprising:
pointing a position on a medium on which a target image is formed, the target image being an image to be read;
irradiating light onto the pointed position;
imaging light reflected from the medium irradiated with the light;
acquiring a signal representing the target image in response to the imaged light; and
changing a direction or a position of the imaging unit.

8. The reading method according to claim 7, wherein the light is irradiated in an irradiation range that is predetermined with respect to the pointed position on the medium.

9. The reading method according to claim 8, wherein the changing includes:
swinging an imaging unit in a predetermined range around a rotation axis, the rotation axis rotatably supporting the imaging unit.

10. The reading method according to claim 7, wherein the direction or the position of an irradiating unit and an imaging unit is changed, according to an amount of variation in the pointed position, so as to change the position on the medium irradiated with the light and the position on the medium at which the light is reflected.

11. The reading method according to claim 10, wherein the amount of variation in the position or the direction of the irradiating unit and the imaging unit is increased, the greater the amount of variation in the pointed position.
